(19) United States
(12) Patent Application Publication
(10) Pub. No.: US 2020/0074761 A1
(43) Pub. Date: Mar. 5, 2020

(54) ON-VEHICLE DEVICE, DATA COLLECTION SYSTEM, AND DATA COLLECTION APPARATUS

(71) Applicant: DENSO TEN Limited, Kobe-shi (JP)

(72) Inventors: Masashi TSUYUNASHI, Kobe-shi (JP); Tomohiro MATSUO, Kobe-shi (JP)

(73) Assignee: DENSO TEN Limited, Kobe-shi (JP)

(21) Appl. No.: 16/552,590

(22) Filed: Aug. 27, 2019

(30) Foreign Application Priority Data
Aug. 31, 2018 (JP) 2018-163947
Aug. 31, 2018 (JP) 2018-163983
Sep. 14, 2018 (JP) 2018-172759

(51) Int. Cl. G07C 5/00; G07C 5/08

(52) U.S. Cl. CPC G07C 5/008; G07C 5/0858

(57) ABSTRACT

An on-vehicle device according to an aspect of an embodiment includes a detector, a generator, and a transmitter. The detector detects abnormality of an own vehicle. The generator generates a collection condition of data related to the abnormality detected by the detector. The transmitter transmits, to an external apparatus, a collection condition generated by the generator and a collection request of data satisfying the collection condition.

### CROSS-REFERENCE TO RELATED APPLICATION

This application is based upon and claims the benefit of priority of the prior Japanese Patent Application No. 2018-163947, filed on Aug. 31, 2018, Japanese Patent Application No. 2018-163983, filed on Aug. 31, 2018 and Japanese Patent Application No. 2018-172759, filed on Sep. 14, 2018, the entire contents of which are incorporated herein by reference.

### FIELD

The embodiments discussed herein are directed to an on-vehicle device, a data collection system, and a data collection apparatus.

### BACKGROUND

Conventionally, data collection apparatuses collecting pieces of road information from on-vehicle devices mounted on vehicles have been known. The data collection apparatuses collect the road information at a desired position by selecting a vehicle as a collection target of the road information based on pieces of positional information of the vehicles (for example, see Japanese Laid-open Patent Publication No. 2018-55581).

In the conventional technique, however, the data collection apparatuses determine what data will be collected. Therefore, there is still room for improvement in efficient data collection.

Accordingly, it is an object in one aspect of an embodiment of the invention to provide an on-vehicle device, a data collection system, a data collection method, and a data collection apparatus capable of collecting data efficiently.

### SUMMARY

an on-vehicle device; includes: a detector that detects abnormality of an own vehicle; a generator that generates a collection condition of data in accordance with the abnormality detected by the detector; and a transmitter that transmits, to the data collection apparatus, a collection request of data with the collection condition generated by the generator.

### BRIEF DESCRIPTION OF DRAWINGS

More complete comprehension and advantages therewith of the present invention will be easily understood by reading the following description of embodiments with reference to accompanying drawings.

FIGS. 1A to 1C are descriptive views for explaining operations of a data collection system.

FIG. 2A is a diagram illustrating an example of tag data.

FIG. 2B is a diagram illustrating an example of a collection condition ID.

FIG. 2C is a data transition diagram in the data collection system.

FIG. 3 is a view for explaining a conventional technique.

FIG. 4 is a view illustrating an example of data collection by a data collection apparatus according to an embodiment.

FIG. 5 is a view illustrating outline of a data collection method according to a first embodiment.

FIG. 6 is a system schematic diagram of the data collection system.

FIG. 7 is a block diagram of the data collection apparatus.

FIG. 8 is a view illustrating an example of a vehicle information table.

FIG. 9 is a view illustrating an example of a collection condition table.

FIG. 10 is a view illustrating an example of a relevance information table.

FIG. 11 is a block diagram of an on-vehicle device.

FIG. 12 is a diagram illustrating an example of a collection condition file.

FIG. 13 is a flowchart illustrating processing procedures that the data collection apparatus executes.

FIG. 14 is a flowchart illustrating processing procedures that the on-vehicle device executes.

### DESCRIPTION OF EMBODIMENTS

Hereinafter, an on-vehicle device, a data collection system, and a data collection method according to an embodiment will be described in detail with reference to the accompanying drawings. The embodiment does not limit the present invention.

### Basic Concept

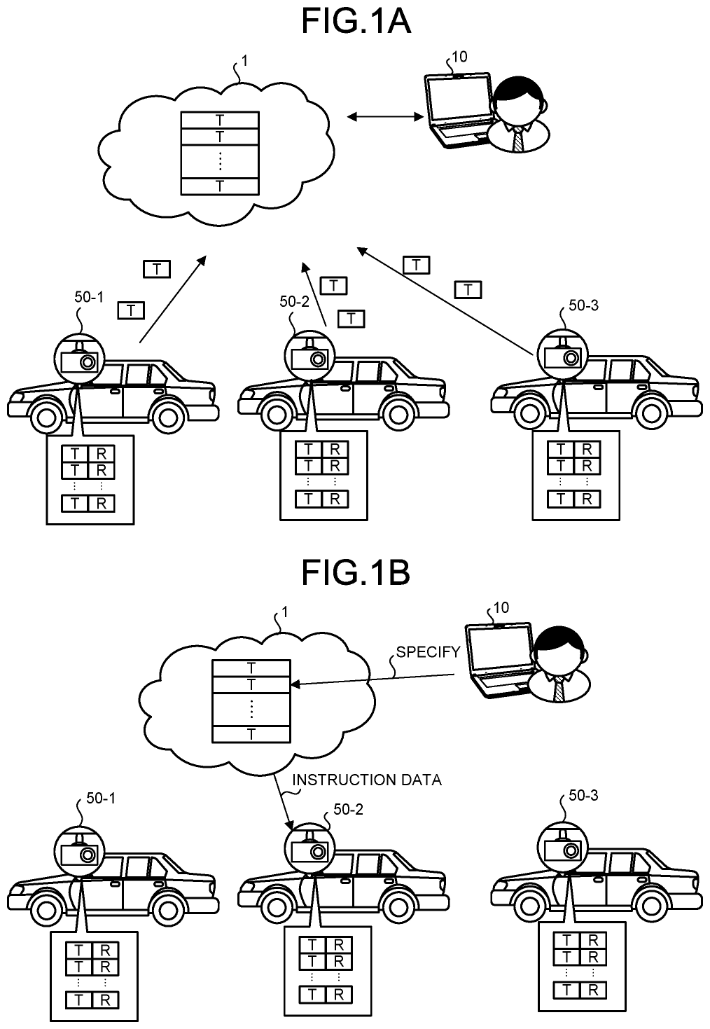

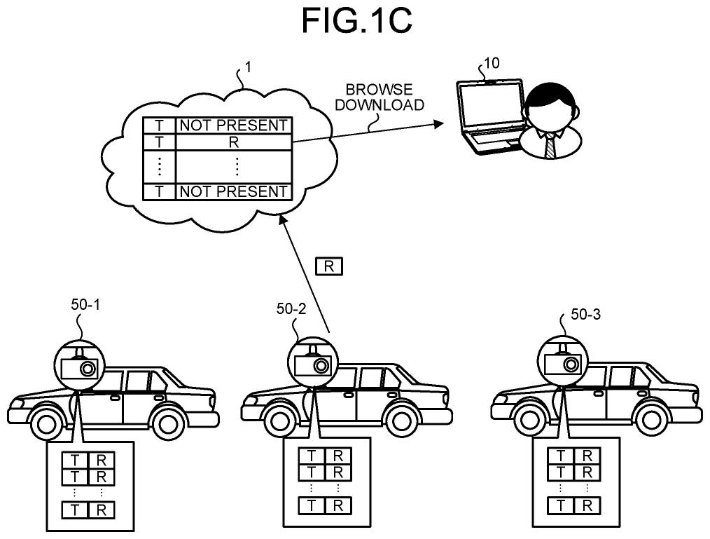

First, overall basic operations for data collection technology will be described using the accompanying drawings of FIGS. 1A to 4. A series of flow until data is provided to a data user in the data collection system will be described with reference to FIGS. 1A to 1C.

FIGS. 1A to 1C are descriptive views for explaining operations of the data collection system. As illustrated in FIG. 1A, the data collection system is configured by a user terminal 10 that a data user such as a developer of automatic driving cars uses, a data collection apparatus (server) 1 formed by a cloud or the like, and on-vehicle devices 50-1, 50-2, 50-3, etc. (referred to as on-vehicle devices 50 when generally referring to on-vehicle devices) mounted on vehicles. It is effective that each of the on-vehicle devices 50 also serves as a drive recorder including a camera, an image storage unit (memory), various sensors such as an acceleration sensor and a global positioning system (GPS), and a microcomputer in a point of efficient sharing and utilization of the hardware configurations thereof.

First, the data user sets a data collection condition using the user terminal 10 connected to the data collection apparatus 1. In this case, the data collection apparatus 1 creates tag data generation data for generating tag data having index data characteristics to be used for data search and outline grasp, the tag data being added to actual data that is collected.

The tag data generation data is generated based on an operation by the data user using a computer program and generation data stored in the user terminal 10 or the data collection apparatus 1. The data collection condition and the tag data generation data are stored in the data collection apparatus 1. The data collection condition and the tag data generation data are transmitted to data collection target vehicles (the data user specifies a vehicle condition) and are stored also in the on-vehicle devices 50.

Each on-vehicle device 50 monitors pieces of output data from the sensors and the camera and stores pieces of actual data R thereof in a storage device when an event satisfying the stored data collection condition occurs. Each on-vehicle device 50 generates and stores therein pieces of tag data T corresponding to the pieces of actual data R based on the pieces of actual data R and the stored data for generating tag data.

Each on-vehicle device 50 transmits the pieces of tag data T to the data collection apparatus 1, and the data collection apparatus 1 stores therein the pieces of tag data T. In this case, the pieces of actual data R are not transmitted to the data collection apparatus 1.

When the data user uses the user terminal 10 to connect it to the data collection apparatus 1 for checking a data collection condition or collecting the actual data R, information based on the pieces of tag data T collected from the data collection apparatus 1 is displayed on the user terminal 10. In this case, an operation screen enabling the data user to perform a data collection instruction operation based on the pieces of tag data T is displayed on the user terminal 10.

When the data user uses the user terminal 10 to perform a specification operation of the actual data R to be collected, instruction data specifying the target actual data R is transmitted to each target on-vehicle device 50 through the data collection apparatus 1.

Thereafter, as illustrated in FIG. 1C, each on-vehicle device 50 transmits, to the data collection apparatus 1, the actual data R (image data or the like) that is instructed to be collected, and the data collection apparatus 1 stores therein the actual data R. The data user uses the user terminal 10 to access the actual data R stored in the data collection apparatus 1 and browses or downloads it.

The actual data R transmitted to the data collection apparatus 1 and the corresponding tag data T are preferably deleted from the on-vehicle device 50 from the viewpoint of the data capacity of the on-vehicle device 50. It is preferable that the tag data T be not data provided by simply extracting a part of the acquired data but tag data provided by converting the acquired data into metadata enabling the data user to grasp outline of the actual data R and to determine the necessity of the actual data R.

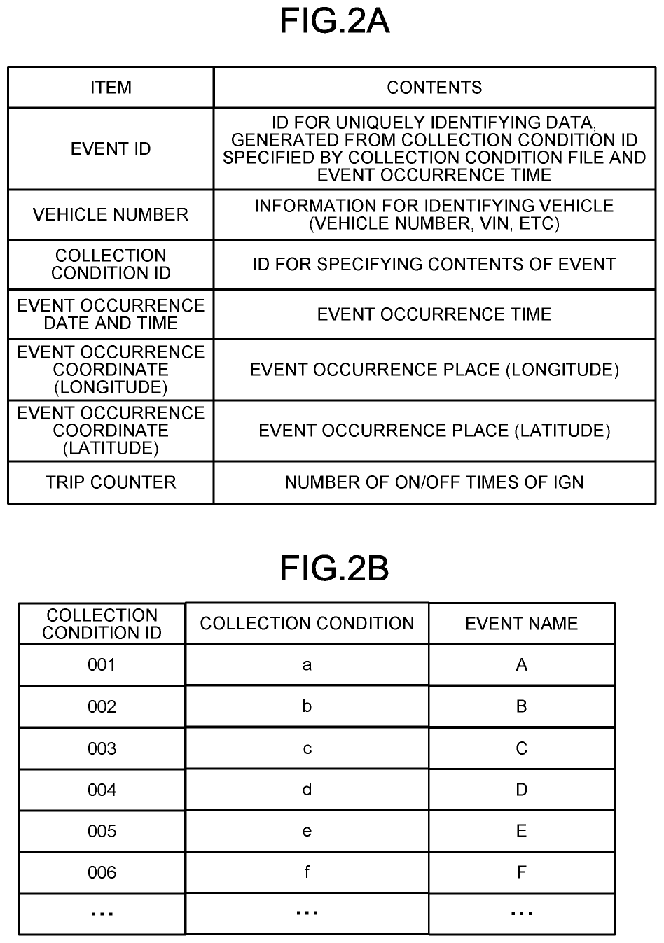

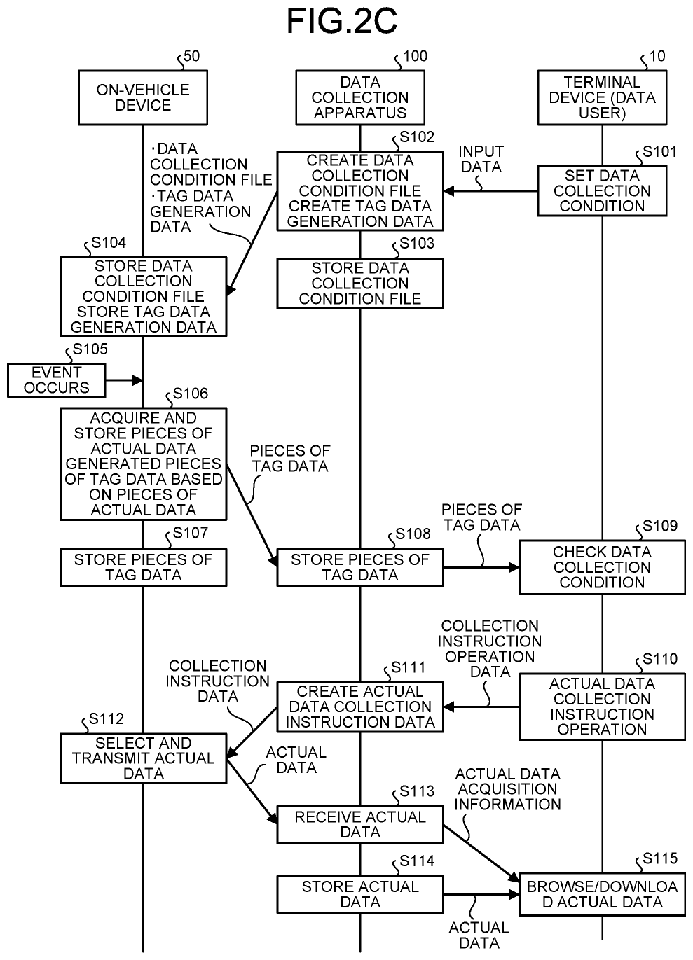

Next, a specific example of the tag data T will be described with reference to FIGS. 2A and 2B. FIG. 2A is a diagram illustrating an example of the tag data T. FIG. 2B is a diagram illustrating an example of a collection condition ID. In the example illustrated in FIG. 2A, the tag data T is formed by an event ID, a vehicle number, the collection condition ID, an event occurrence date and time, event occurrence coordinates (longitude and latitude), and a Trip counter.

The event ID is an identification code for uniquely identifying data and is generated from the collection condition ID specified by a collection condition file and the event occurrence time. For example, when the collection condition ID is 001 and the generation order is the first, the event ID is “0010001”. The vehicle number is an identification number of each vehicle, and the event occurrence date and time is data of the date and time at which an event (state satisfying the data collection condition) occurs. The event occurrence coordinates (longitude and latitude) are positional data at which the event occurs, and the Trip counter is the number of ON/OFF times of an ignition switch (the number of engine ON/OFF times from a predetermined time point such as a data collection start time point).

The collection condition ID is data for identifying the data collection condition correlated to the collection condition data (file) as illustrated in FIG. 2B and set for the on-vehicle devices 50. The data collection conditions are set for the on-vehicle devices 50 when a plurality of data users perform data collection or when a single data user desires to collect pieces of data under a plurality of different conditions.

The common collection condition data is stored in the on-vehicle devices 50 and the data collection apparatus 1. The on-vehicle device 50 that is not a collection target under a certain condition does not store the collection condition data in the collection condition file stored in the on-vehicle device 50.

A simple data structure of the collection condition data (file) is configured by collection condition ID data for identifying the collection condition and collection condition data indicating a collection condition content, and an event name (to be used for display) enabling the data user to easily understand on screen display is preferably correlated to them.

In the example illustrated in FIG. 2B, the ID indicating the collection condition and the name thereof are used for the tag data T. Alternatively, a method in which the pieces of actual data R are divided into leveled data types and level data thereof is used for the tag data T or a method in which leveled information in terms of a collection condition achievement level as addition data of the data collection condition, for example, information provided by determining the risk degree (long inter-vehicle distance: low interruption risk degree, middle inter-vehicle distance: middle interruption risk degree, short inter-vehicle distance: high interruption risk degree) based on an inter-vehicle distance level to a preceding vehicle before occurrence of interruption in detection of an interrupting vehicle is used for the tag data T is also a preferable method.

When the above-mentioned system is formed by the cloud, the on-vehicle devices 50 as described above tag pieces of collected data with pieces of information such as the time, position, and speed, and upload to the cloud, only the pieces of tag data T as meta information, and store data main bodies such as images in the on-vehicle devices 50. When the data user such as the service developer desires to acquire necessary data from the on-vehicle device 50, it identifies a target vehicle by referring to the pieces of metadata collected on the cloud. Then, the system extracts an image recorded in the vehicle, so that the actual data R is collected.

With this system, pieces of large-volume image data need not to be stored on the cloud, and only the necessary actual data R can be collected by managing and referring to only the pieces of low-capacity tag data T.

In, for example, development of automatic driving, the developer needs the actual data R related to a dangerous interruption scene. Various types of interruptions are supposed to occur with a road environment that changes moment by moment. To cope with this, the data collection system according to the embodiment manages pieces of data with a tagged function, thereby easily finding only the dangerous interruption scenes.

Next, flow of pieces of processing and data of the constituent devices (the on-vehicle devices 50, the data collection apparatus, and the terminal device (data user)) of the data collection system will be described with reference to a processing and data transition diagram in FIG. 2C. FIG. 2C is the data transition diagram in the data collection system. Although only one on-vehicle device 50 is illustrated, all of the on-vehicle devices 50 specified as the data collection targets perform similar operations.

When the data user inputs a data collection condition using the user terminal 10 (step S101), input data related to the data collection condition is transmitted to the data collection apparatus 1. The data collection apparatus 1 thereby creates a data collection condition data file based on the input data related to the data collection condition and tag data generation data that is used for generating the tag data T corresponding to actual data based on the actual data (step S102).

The data collection condition data file and the tag data generation data that have been created are transmitted to the on-vehicle device 50, and the data collection condition data file is stored in the data collection apparatus 1 (step S103). The on-vehicle device 50 stores therein the data collection condition data file and the tag data generation data transmitted from the data collection apparatus 1 (step S104).

Subsequently, when an event matching with the data collection condition contained in the data collection condition data file occurs (step S105: determine based on outputs from the sensors in the vehicle), the on-vehicle device 50 acquires and stores pieces of data as collection targets from the sensors in the vehicle (by referring to data in the data collection condition data file) and generates the pieces of tag data T based on the pieces of actual data (step S106).

The on-vehicle device 50 then stores therein the pieces of generated tag data T (step S107). The pieces of generated tag data T are transmitted to the data collection apparatus 1, and the data collection apparatus 1 stores therein the pieces of transmitted tag data T (step S108). These pieces of processing (pieces of processing at step S105 to step S108) in occurrence of the event are performed as appropriate upon occurrence of the event.

The pieces of tag data T stored in the data collection apparatus 1 are provided to the user terminal 10 with an operation on the user terminal 10 by the data user, and a data collection condition and an operation screen for collecting the actual data are displayed on the user terminal 10. The data user can thereby check the data collection condition (step S109).

In this case, when the data user performs a collection instruction operation for necessary actual data R based on the pieces of tag data T (step S110), collection instruction operation data is transmitted to the data collection apparatus 1, and the data collection apparatus 1 creates collection instruction data containing actual data identification data as a collection target based on the collection instruction operation data (step S111). The collection instruction data is transmitted to the on-vehicle device 50.

Then, the on-vehicle device 50 selects collection target actual data based on the received collection instruction data and transmits the actual data to the data collection apparatus 1 (step S112).

Thereafter, the data collection apparatus 1 receives the actual data R transmitted from the on-vehicle device 50 (step S113), transmits actual data acquisition information indicating acquisition of the actual data R to the user terminal 10, and stores the received actual data R (step S114). The data user operates the user terminal 10 to access the actual data R stored in the data collection apparatus 1 and browses or downloads the stored actual data R (step S115).

The data user can efficiently collect the necessary actual data with the above-mentioned flow. The pieces of data are processed, accumulated, and transmitted with the above-mentioned flow, so that data processing, storage loads on the apparatuses, and data transfer loads between the apparatuses can be reduced.

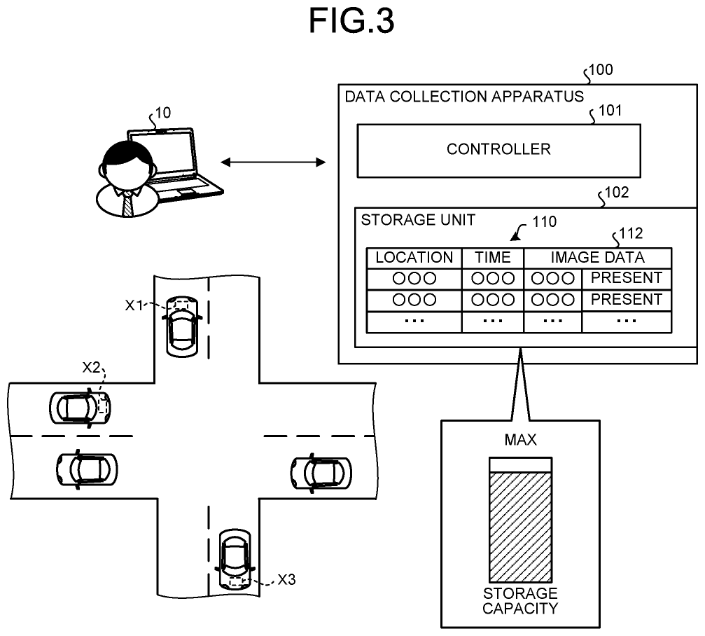

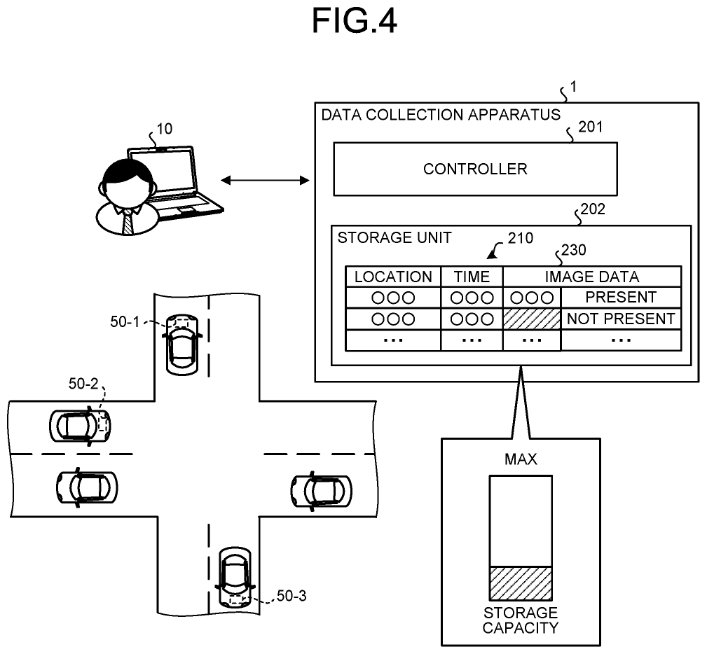

Next, a data collection example will be described using map (road) data as a specific data type as an example. In the following, for easy understanding of the description, first, a conventional data collection system is described with reference to FIG. 3, and then, the data collection system of the present application is described with reference to FIG. 4.

FIG. 3 is a view for explaining the conventional technique. FIG. 4 is a view illustrating an example of data collection by the data collection apparatus according to the embodiment.

As illustrated in FIG. 3, in the conventional data collection system, on-vehicle devices X1, X2, etc. transmit pieces of data such as pieces of positional data, pieces of time data, and pieces of image data acquired by on-vehicle sensors and the like to a data collection apparatus (server) 100 while adding pieces of necessary additional data such as pieces of vehicle identification data thereto. A user or the like previously sets an acquisition data type (which type of data is to be acquired, for example, data of a position, time, image, speed, vibration, inclination, or the like) and a data acquisition range (road section, period) via the data collection apparatus 1, and the on-vehicle devices X1, X2, etc. acquire pieces of set data from corresponding sensors.

In the above-described conventional data collection system, all pieces of image data in a specified section in which vehicles travel are transmitted to the data collection apparatus 100 such as a cloud. For example, for a road with heavy traffic, data overlap is increased and a large amount of actual data more than necessary is collected. Consequently, a large amount of collected data 110 is accumulated in a storage unit 102 of the data collection apparatus 100. The data volume therefore becomes large, resulting in the problem that the storage capacity of the storage unit 102 of the data collection apparatus 100 is oppressed. In particular, image data 112 has large data volume, causing not only increase in communication load but also oppression in the storage capacity of the storage unit 102.

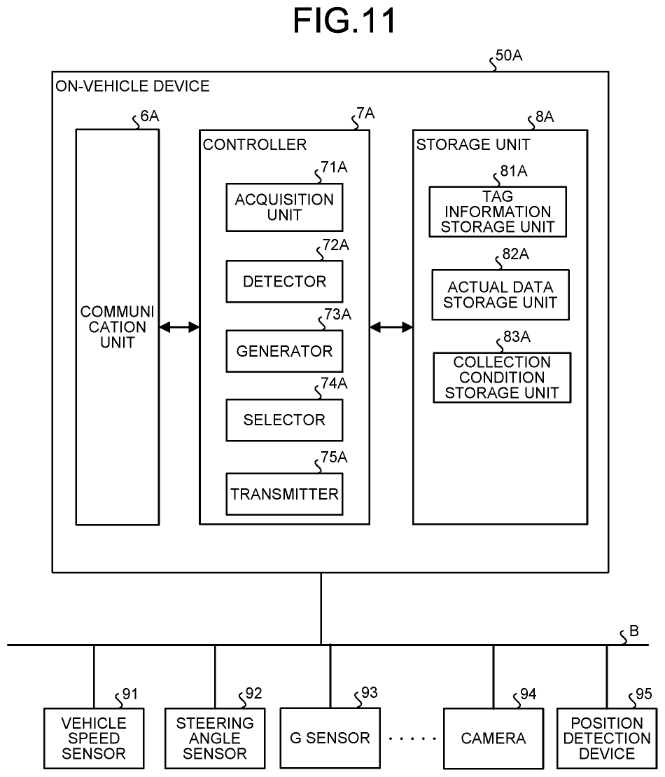

An embodiment example dealing with this problem is the embodiment illustrated in FIG. 4. An example of the specific configuration of the data collection apparatus 1 will be described later with reference to FIGS. 7 and 17. An example of the specific configuration of the on-vehicle device 50 will be described later with reference to FIGS. 11 and 19.

As illustrated in FIG. 4, in the data collection system in the embodiment, for pieces of data such as pieces of positional data, pieces of time data, and pieces of image data acquired by the on-vehicle sensors and the like, the on-vehicle devices 50-1, 50-2, etc. collect the pieces of actual data R from the sensors under the data collection condition specified by the data collection apparatus 1 and generate the pieces of tag data T based on the tag data generation condition specified by the data collection apparatus 1.

Then, the pieces of generated tag data T and the pieces of corresponding actual data R are accumulated in the on-vehicle devices 50-1, 50-2, etc. (the on-vehicle devices that have generated them). The data collection apparatus 1 generates the data collection condition such as the data type to be collected by the on-vehicle devices 50-1, 50-2, etc. and the tag data generation condition information for generating the tag data based on an operation on the user terminal 10 by the data user and stores them in a storage unit 202 of the data collection apparatus 1. The tag data generation condition information is transmitted to the on-vehicle devices 50-1, 50-2, etc. as the data collection targets and is stored in storage units thereof.

The pieces of tag data T generated by the on-vehicle devices 50 are transmitted to the data collection apparatus 1, and the data collection apparatus 1 accumulates therein the piece of tag data T. In this case, the on-vehicle devices 50 do not transmit the pieces of actual data R to the data collection apparatus 1.

When the data user such as the service developer desires to acquire necessary data from the on-vehicle devices 50, the data user specifies the target vehicle by referring to the pieces of tag data T collected and accumulated in the data collection apparatus 1 through the user terminal 10 connected to the data collection apparatus 1 in a communicable manner to perform the data collection instruction operation.

The data collection apparatus 1 identifies the vehicle with the actual data R to be collected based on the pieces of accumulated tag data T and transmits, to the on-vehicle device 50-1, 50-2, etc. of the vehicle, a transmission instruction of the actual data as the collection target. The data collection apparatus 1 thereby collects the data by extracting the target actual data (image data 230 or the like) accumulated in the on-vehicle device 50-1, 50-2, etc.

The operation screen for specification of the data collection condition, the actual data collection instruction operation based on the pieces of tag data T, and the like is generated and displayed on the user terminal 10 by referring to the pieces of tag data T and the like in the data collection apparatus 1.

In order to identify the vehicle from which the actual data R is to be collected, in addition to the above-mentioned method in which the vehicle itself is identified and specified, a method in which a vehicle condition is specified is also considered. For example, a method of collecting the actual data R of the corresponding vehicle by specifying a condition such as a vehicle model, a traveling position (region), the traveling time (time band), and a vehicle in which a specific event occurs is also considered.

With this system, the image data 230 having large volume, for example, need not to be stored in the data collection apparatus 1, so that only necessary image data can be collected by managing and referring to only the pieces of low-capacity tag data T. That is to say, oppression of the storage capacity of the storage unit 202 of the data collection apparatus 1 can be substantially prevented.

When the developer needs data of a dangerous interruption scene in the development of automatic driving, for example, only the dangerous interruption scene can be found based on the pieces of tag data T and only image data thereof can be collected because the pieces of data are managed with the tagged function although various types of interruptions occur with the road environment that changes moment by moment.

For example, the time at which vehicles have traveled and pieces of positional information thereof are transmitted to the data collection apparatus 1 as the pieces of tag data T. Accordingly, when the developer needs image data of a certain road, the vehicle that has passed through the target road is identified by referring to the pieces of tag data T in the data collection apparatus 1. The developer may acquire the image data from the vehicle through the data collection apparatus 1.

Connected cars from which pieces of data are collected and provided to a center are expected to be increased in the future and the pieces of data to be collected therefrom are also expected to become huge. Efficient collection of only data matching with needs of the data user such as the service developer by utilizing the pieces of tag data T as in the embodiment can be applied to various services.

All of the pieces of tag data T matching with the data collection condition may be stored in the data collection apparatus 1 because the pieces of tag data T have small data volume. When there is a large difference in the traffic amount among road sections for which data collection is specified, processing of thinning out generation, transmission, and accumulation of the pieces of tag data T, processing of deleting pieces of old data when the pieces of data exceed an appropriate collection amount, or another processing may be performed for a road section with heavy traffic. In such a case, by contrast, processing of moderating the data collection condition and interpolatingly collecting similar data or another processing may be performed for a road section with little traffic.

In this case, preferably, the data user is made to be capable of taking an appropriate countermeasure by notifying the data user of the fact or displaying information thereof on the operation screen that is used for instructing actual data collection to provide an operation screen enabling the data user to select target data.

Next, important points of technical features in the above-mentioned embodiment will be described.

Technical Feature 1: Data capable of identifying a route section on road is contained as the tag data (contained in the data collection condition). With this technical feature 1, data selection based on the route section can be made.

Technical Feature 2: In the technical feature 1, the data collection apparatus performs actual data collection instruction such that the collection data amount (quantity) is uniform among the route sections. With this technical feature 2, the pieces of actual data can be collected without depending on the difference in the traffic amount among the route sections, thereby preventing useless actual data collection due to the difference in the data collection amount among the route sections.

Technical Feature 3: In the technical feature 1, the data collection apparatus sets the data collection condition such that the collection data amount (quantity) is uniform among the route sections. For example, such thinning-out condition that data is acquired once every time the data collection condition is established n times is contained in the data collection condition. With this technical feature 3, the acquisition amount of the pieces of actual data by the on-vehicle devices can be made constant without depending on the difference in the traffic amount among the route sections, thereby preventing useless actual data collection due to the difference in the data collection amount among the route sections and reducing data processing, storage loads, and data transmission loads of the on-vehicle devices and the like.

Technical Feature 4: Metadata is formed of the pieces of tag data that are generated and stored. With this technical feature 4, the data user or the like can easily grasp data contents to facilitate selection of the actual data that is collected, and so on.

Technical Feature 5: In the technical feature 4, metadata related to an item of the collection condition is formed. The data user sets the collection condition, so that the data user or the like can grasp data contents more easily to facilitate selection of the actual data that is collected, and so on by using the metadata related thereto.

Technical Feature 6: In the technical feature 4 or 5, in formation of metadata related to a certain item (collection condition or the like), metadata of level information of the item is also formed. Specific selection based on the level of the certain item can be made to facilitate more specific selection of the actual data that is collected, and so on.

### First Embodiment

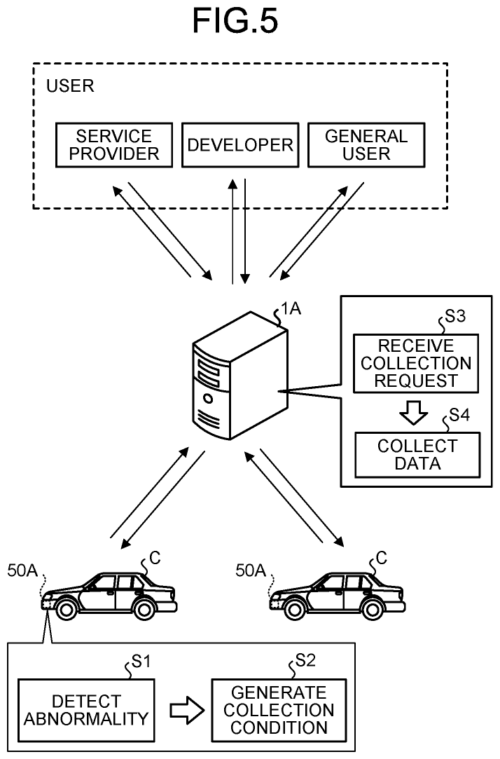

Subsequently, a data collection method according to a first embodiment will be described. FIG. 5 is a view illustrating an outline of the data collection method. The data collection method is implemented by data communication between a data collection apparatus 1A and on-vehicle devices 50A illustrated in FIG. 5.

The data collection apparatus 1A is a server apparatus that receives data collection demands from users, collects pieces of data from the on-vehicle devices 50 based on the received collection demands, and provides the pieces of collected data to each of the users.

In the example illustrated in FIG. 5, the users are a service provider, a developer, and a general user. That is to say, the data collection apparatus 1A collects pieces of data that these users desire for the users and provides the pieces of collected data. It is to be noted that the data collection apparatus 1A is an example of an external apparatus.

In the data collection apparatus, the users or the data collection apparatus determine(s) pieces of data to be collected from the on-vehicle devices, in general. When the data collection apparatus determines all of data collection conditions, for example, processing load on the data collection apparatus increases, causing a failure in efficient data collection.

For this reason, with the data collection method in the embodiment, the on-vehicle devices 50A autonomously generate collection conditions. To be specific, as illustrated in FIG. 5, first, when the on-vehicle device 50A detects abnormality of an own vehicle MC (step S1), it generates a collection condition based on the detected abnormality (step S2).

For example, the on-vehicle device 50A is connected to various sensors of the own vehicle MC and can detect the abnormality of the own vehicle MC based on signals input from the various sensors. The on-vehicle device 50A can detect abnormality with low reproducibility that causes no diagnosis output in the signals input from the various sensors.

The on-vehicle device 50A transmits, to the data collection apparatus 1A, the generated collection condition and a data collection demand satisfying the collection condition. When the data collection apparatus 1A thereby receives a collection request containing the collection condition (step S3), it collects pieces of data based on the received collection condition (step S4).

Thus, with the data collection method in the embodiment, the on-vehicle devices 50A can autonomously generate the collection conditions. It is therefore sufficient that the data collection apparatus 1A collects pieces of data based on the collection conditions generated by the on-vehicle devices 50A, and processing of generating the collection conditions can be omitted.

That is to say, with the data collection method in the embodiment, efficient data collection can be made by reducing the processing load on the data collection apparatus 1A.

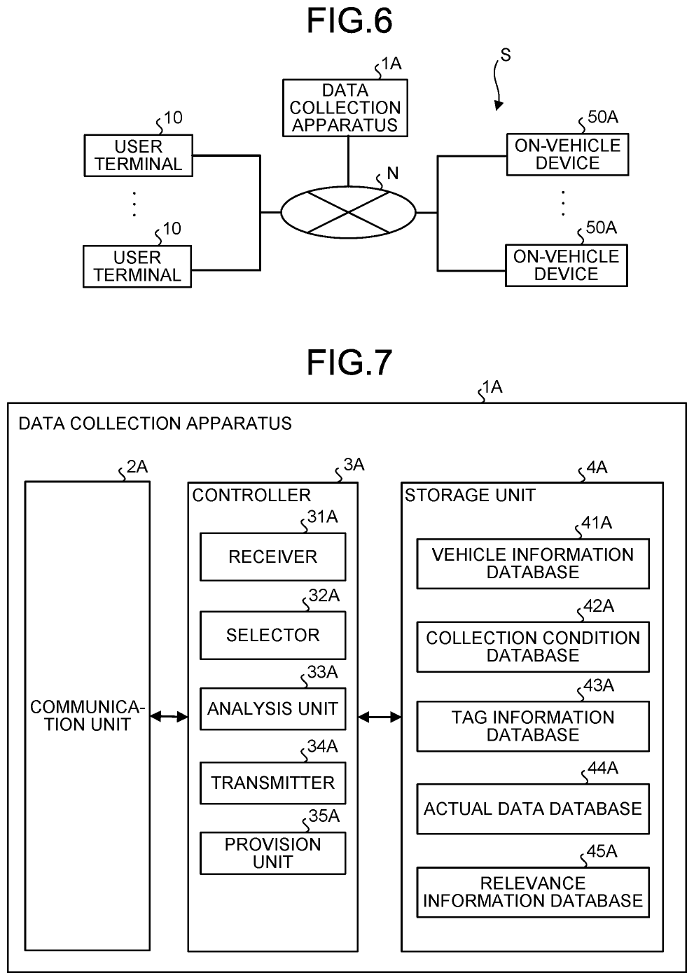

Next, the configuration of the data collection system in the embodiment will be described with reference to FIG. 6. FIG. 6 is a diagram illustrating an example of the configuration of the data collection system. As illustrated in FIG. 6, a data collection system S includes the data collection apparatus 1A, the user terminals 10, and the on-vehicle devices 50A.

The data collection apparatus 1A, the user terminals 10, and the on-vehicle devices 50A are connected via a network N. The data collection apparatus 1A collects pieces of data from the on-vehicle devices 50A based on collection demands received from the user terminals 10 and provides the pieces of collected data to the user terminals 10.

Each user terminal 10 is a terminal that a user operates and is a cellular phone such as a smart phone, a tablet terminal, a personal digital assistant (PDA), a desktop-type personal computer (PC), a notebook-type PC, or the like. The user terminal 10 includes a computer having a central processing unit (CPU), a read only memory (ROM), a random access memory (RAM), a hard disk drive (HDD), and an input/output port and various circuits.

Each on-vehicle device 50A is a communication device mounted on a vehicle. The on-vehicle device 50A stores vehicle traveling information and the like in a storage medium therein, selects data based on a transmission demand transmitted from the data collection apparatus 1A, and transmits the selected data to the data collection apparatus 1 A.

Next, an example of the configuration of the data collection apparatus 1A in the embodiment will be described with reference to FIG. 7. FIG. 7 is a block diagram of the data collection apparatus 1A. As illustrated in FIG. 7, the data collection apparatus 1A includes a communication unit 2A, a controller 3A, and a storage unit 4A.

The communication unit 2A is a communication interface that transmits and receives information to and from the network N. The controller 3A can transmit and receive various pieces of information to and from components through the communication unit 2A and the network N.

The controller 3A includes a receiver 31A, a selector 32A, an analysis unit 33A, a transmitter 34A, and a provision unit 35A. The controller 3A includes, for example, a computer having a CPU, a ROM, a RAM, an HDD, and an input/output port and various circuits.

The CPU of the computer functions as the receiver 31A, the selector 32A, the analysis unit 33A, the transmitter 34A, and the provision unit 35A of the controller 3A by reading and executing a computer program stored in the ROM, for example.

At least some or all of the receiver 31A, the selector 32A, the analysis unit 33A, the transmitter 34A, and the provision unit 35A of the controller 3A can also be configured by hardware such as an application specific integrated circuit (ASIC) and a field programmable gate array (FPGA).

The storage unit 4A corresponds to, for example, the RAM or the HDD. The RAM or the HDD includes a vehicle information database 41A, a collection condition database 42A, a tag information database 43A, an actual data database 44A, and a relevance information database 45A. The data collection apparatus 1A may acquire the above-mentioned computer program and various pieces of information through another computer connected via a wired or wireless network or a portable recording medium.

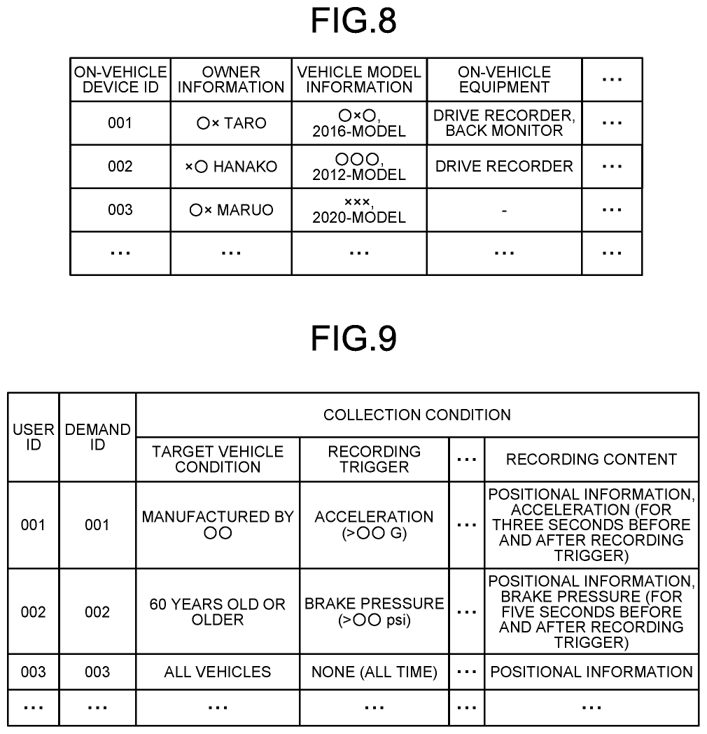

The vehicle information database 41A has a vehicle information table related to the vehicles. FIG. 8 is a view illustrating an example of the vehicle information table. As illustrated in FIG. 8, a vehicle information table 41a is information in which an “on-vehicle device ID”, “owner information”, “vehicle model information, “on-vehicle equipment”, and the like are correlated to one another.

The “on-vehicle device ID” is an identifier for identifying each on-vehicle device 50A. The “owner information” is information related to an owner of the vehicle on which the on-vehicle device 50A is mounted. In the example illustrated in FIG. 8, the name of the owner is indicated as the owner information. Alternatively, the gender, address, occupation, or the like of the owner may be included in the owner information.

The “vehicle model information” is information related to the vehicle model of the vehicle and is information related to a vehicle model name or model year thereof. The “on-vehicle equipment” is information related to equipment of the vehicle. The vehicle information includes, for example, pieces of information indicating presence of a camera, a type of the camera, and the like.

The collection condition database 42A will be described with reference to FIG. 7 again. The collection condition database 42A has a collection condition table related to the collection conditions received from the user terminals 10. FIG. 9 is a view illustrating an example of the collection condition table.

As illustrated in FIG. 9, a collection condition table 42a is information in which a “user ID”, a “demand ID”, and the “collection condition” are correlated to one another. The “user ID” is an identifier for identifying the user.

The “demand ID” is an identifier for identifying the collection demand. The “collection condition” is information indicating an actual data collection condition. The collection condition includes, for example, a “target vehicle condition”, a “recording trigger”, and a “collection content”.

The “target vehicle condition” indicates a condition of vehicles as collection targets, and the “recording trigger” is a trigger by which recording of the actual data is started in the on-vehicle devices 50A. The “collection content” is information indicating the actual data that is recorded in the on-vehicle devices 50A.

In the example illustrated in FIG. 9, the target vehicles of a demand ID “001” are vehicles “manufactured by XX”, the recording trigger is acceleration (>YY G), and the collection content is positional information and acceleration (for three seconds before and after the recording trigger).

In this case, when the on-vehicle device 50A detects that the acceleration exceeds YY G, pieces of data of the acceleration for three seconds before and after the time point at which the acceleration exceeds YY G as a reference are recorded together with the pieces of positional information.

The target vehicles of a demand ID “002” are users of equal to or older than 60 years old, the recording trigger is a brake pressure (>ZZ psi), and recording is made (for five seconds before and after) the time point at which brake pressure exceeds ZZ psi as a reference.

In this case, when the on-vehicle device 50A detects that the brake pressure exceeds ZZ psi, pieces of data of the brake pressure for five seconds before and after the time point at which the acceleration exceeds YY G as a reference are recorded together with the pieces of positional information.

As indicated in a demand ID “003”, the target vehicles can be set to all vehicles. As indicated in the demand ID “003”, no recording trigger can be set and data can be recorded all the time.

The tag information database 43A will be described with reference to FIG. 7 again. The tag information database 43A is a database in which pieces of tag information transmitted from the on-vehicle devices 50A are stored. For example, information related to the time, a tag information ID, the on-vehicle device ID, and the like are added to the tag information for each above-mentioned demand ID and they are stored in the tag information database 43A. The tag information database 43A is an example of a tag information storage unit.

The actual data database 44A is a database in which the pieces of actual data collected from the on-vehicle devices 50A are stored based on the pieces of tag information. The provision unit 35A appropriately provides, to the users, the pieces of information stored in the tag information database 43A and the actual data database 44A.

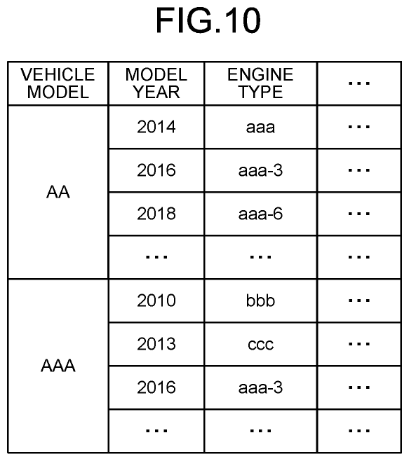

The relevance information database 45A has a relevance information table indicating relevance between devices mounted on the vehicles. FIG. 10 is a view illustrating an example of the relevance information table.

As illustrated in FIG. 10, a relevance information table 45a is information in which a “vehicle model”, a “model year”, an “engine type”, and the like are correlated to one another. The “vehicle model” indicates the name of the vehicle, and the “model year” indicates the model year of the vehicle. The “engine type” indicates the type of an engine mounted on the vehicle. The data collection apparatus 1 can acquire the relevance information table 45a from, for example, a vehicle manufacturer.

The relevance information table 45a includes the vehicle model, the model year, and the engine type as examples, but is not limited thereto. Information related to another component mounted on each vehicle may be registered in the relevance information table 45a.

Then, the components of the controller 3A will be described. The receiver 31A of the controller 3A receives, from each user terminal 10, the collection demand containing the collection condition of target data as a collection target. When the receiver 31A receives the collection condition, it adds the above-mentioned demand ID to the collection condition and registers it in the collection condition database 42A.

The receiver 31A functions as a tag information receiver. The receiver 31A receives tag update information of the tag information from each on-vehicle devices 50A and updates the storage contents in the tag information database 43A with the received tag update information, so that the tag information stored in each on-vehicle device 50A and the tag information stored in the tag information database 43A can be synchronized with each other.

The receiver 31A functions as an actual data receiver. When the receiver 31A receives the actual data from any of the on-vehicle devices 50A, it registers the actual data in the actual data database 44A.

The receiver 31A can also receive, from each user terminal 10, specification of target data for which the transmission demand is transmitted. When the receiver 31A receives the specification of the target data, it notifies the transmitter 34A of it.

The receiver 31A can also receive the collection condition and the collection request generated by each on-vehicle device 50A. The collection request includes data when abnormality occurs (hereinafter, referred to as abnormal data) and an analysis request for the data. The receiver 31A registers the collection condition in the collection condition database 42A and notifies the analysis unit 33A of the abnormal data and the analysis request. Hereinafter, the vehicle of the on-vehicle device 50A that has made the collection request is referred to as a request vehicle.

Thereafter, the receiver 31A can also collect data satisfying the collection condition from the request vehicle. That is to say, the receiver 31A also functions as a collector collecting pieces of data from the other on-vehicle devices 50A based on the collection request of the on-vehicle device 50A.

The selector 32A selects a vehicle satisfying the collection condition. The selector 32A selects the vehicle satisfying the collection condition registered in the collection condition database 42A by referring to the vehicle information database 41A. In this case, when one vehicle satisfies a plurality of collection conditions, the collection conditions are applied to the one vehicle.

The selector 32A generates a collection condition file indicating the collection condition for each vehicle and notifies the transmitter 34A of it. When the collection condition database 42A is updated, the selector 32A can also update each collection condition.

In this case, the selector 32A can also select the vehicle satisfying the collection condition based on the on-vehicle equipment in the vehicle information table 41a (see FIG. 8). To be specific, when the collection condition contains a camera image, the selector 32A can determine that vehicles with no camera as their on-vehicle equipment do not satisfy the collection condition.

The selector 32A can also select the vehicle satisfying the collection condition based on the collection condition generated by the on-vehicle device 50A. To be specific, the selector 32A selects, from the vehicle information database 41A, the vehicle of which vehicle model is the same as the request vehicle. The selector 32A updates the collection condition file for the vehicle.

When the tag information corresponding to the collection condition has not been acquired for a predetermined period of time or when the number of the pieces of collected tag information is not sufficient, the selector 32A can extend a collection range based on the relevance information database 45A.

To be specific, the selector 32A extends the collection range such that the collection condition covers, from the same vehicle model, rebadged vehicle models thereof and vehicle models of the same engine type. The selector 32A can efficiently collect data by gradually extending the collection range as described above.

Although the selector 32A extends the above-mentioned collection range based on the relevance information database 45A in this example, it is not limited to extend the collection range in this manner. The selector 32A can also extend the collection range based on a vehicle location, for example. This is because the cause of the abnormality can be related to climatic factors such as the temperature.

The analysis unit 33A analyzes the abnormal data of the request vehicle and notifies the request vehicle of an analysis result. That is to say, the analysis unit 33A performs detail analysis on the data detected to be abnormal in the request vehicle.

When the analysis unit 33A cannot find abnormality in the abnormal data as a result of the analysis, it is highly possible that the detection itself of the abnormality by the request vehicle is erroneous. In this case, the analysis unit 33A can update a computer program for detecting abnormality in the request vehicle. The abnormality detection program of each on-vehicle device 50A can thereby be optimized if needed.

The transmitter 34A transmits the collection condition file generated by the selector 32A to each on-vehicle device 50A. The collection condition file contains the collection condition generated by the on-vehicle device 50A as described above.

The transmitter 34A transmits, to each on-vehicle device 50A, the collection condition generated by each on-vehicle device 50A. The collection condition file is a file indicating the collection condition of the tag information.

The transmitter 34A can also transmit, to the on-vehicle device 50A, for example, a transmission demand for traveling data corresponding to the tag information based on the tag information in accordance with an instruction from the developer. Only the minimum necessary traveling data can thereby be collected.

The provision unit 35A provides the tag information and the actual data to the user terminal 10 of the developer and provides, to the on-vehicle device 50A, the analysis result of the abnormal data by the analysis unit 33A or the developer.

The provision unit 35A, for example, provides the tag information of the abnormal data to the user terminal 10 and receives specification indicating which abnormal data is to be collected. Thereafter, the specified abnormal data can be collected and provided to the user terminal 10 of the developer.

The provision unit 35A provides the analysis result of the abnormal data to the on-vehicle device 50A, thereby taking an acute countermeasure against the abnormality.

Next, an example of the configuration of the on-vehicle device 50A will be described with reference to FIG. 11. FIG. 11 is a block diagram of the on-vehicle device 50A. FIG. 11 illustrates a vehicle speed sensor 91 detecting a vehicle speed of the vehicle, a steering angle sensor 92 detecting a steering angle of the vehicle, a G sensor 93 detecting an acceleration of the vehicle, a camera 94 shooting a periphery of the vehicle, and a position detection device 95 detecting a position of the vehicle.

The vehicle speed sensor 91, the steering angle sensor 92, the G sensor 93, the camera 94, and the position detection device 95 are connected to the on-vehicle device 50A through an on-vehicle network B such as CAN communication.

The on-vehicle device 50A includes a communication unit 6A, a controller 7A, and a storage unit 8A. The communication unit 6A is a communication interface that transmits and receives information to and from the network N. The controller 7A can transmit and receive various pieces of information to and from components through the communication unit 6A and the network N.

The controller 7A includes an acquisition unit 71A, a detector 72A, a generator 73A, a selector 74A, and a transmitter 75A. The controller 7A, for example, includes a computer having a CPU, a ROM, a RAM, an HDD, and an input/output port and various circuits.

The CPU of the computer functions as the acquisition unit 71A, the detector 72A, the generator 73A, the selector 74A, and the transmitter 75A of the controller 7A by reading and executing a computer program stored in the ROM, for example.

At least some or all of the acquisition unit 71A, the detector 72A, the generator 73A, the selector 74A, and the transmitter 75A of the controller 7A can also be configured by hardware such as an ASIC and an FPGA.

The storage unit 8A corresponds to, for example, the RAM and the HDD. The RAM and the HDD include a tag information storage unit 81A, an actual data storage unit 82A, and a collection condition storage unit 83A. The on-vehicle device 50A may acquire the above-mentioned computer program and various pieces of information through another computer connected via a wired or wireless network or a portable recording medium.

The tag information storage unit 81A will be described. The tag information is data having a role as index data of corresponding actual data and is, for example, information that is used when the user, for example, determines the necessity to check the actual data.

To be specific, the tag information is date and time data of a trigger (collection condition establishment time point), positional data, the data size of the actual data, or a value level of a trigger occurrence cause (when, for example, an acceleration value is the trigger, a level of the acceleration value (less than a threshold, to twice the threshold, to three times the threshold, and so on)). The tag information is generated based on the actual data. The tag information can be generated by, for the date and time data, the positional data, and the like, detection values (work of rounding significant figures or another work is performed if necessary) or by, for the level value, performing processing on a detection value with a predetermined formula, processing thereon with table data of the detection value, or another processing. The thus generated tag information is stored in the tag information storage unit 81A.

The volume of the tag information is smaller than that of the actual data and does not cause a significant problem for the storage capacity. The necessity of the tag information is eliminated (lowered) with deletion of the actual data and may therefore be deleted in synchronization with the actual data when the storage capacity is not enough.

The tag information is used for selection and search of the actual data by the user, and real-time property is therefore important. Accordingly, the tag information is transmitted to the data collection apparatus 1A rapidly (immediately when communication can be made) upon generation of the tag information.

The tag information stored in each on-vehicle device 50A and the tag information stored in the data collection apparatus 1A need to be the same data. For this reason, when the tag information is updated (newly generated or deleted) in each on-vehicle device 50A, the information needs to be transmitted to the data collection apparatus 1A rapidly and the tag information in the data collection apparatus 1A needs to be updated synchronously. When the tag information is deleted in the data collection apparatus 1A, the tag information and the corresponding actual data may be deleted in the on-vehicle device 50A when the capacity of the storage device therein is not enough.

The actual data storage unit 82A is a storage unit that stores therein actual data (target actual data) of a collection target type satisfying the collection condition. The actual data storage unit 82A stores therein the actual data and the tag information in a corresponding manner. The actual data storage unit 82A is, for example, a storage medium of a ring buffer scheme, and the actual data is overwritten by new data in the order from the oldest actual data if needed.

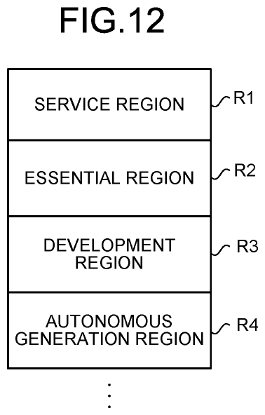

The collection condition storage unit 83A is a storage unit in which the data collection conditions for each on-vehicle device 50A are described. FIG. 12 is a diagram illustrating an example of the collection condition storage unit 83A.

As illustrated in FIG. 12, the collection condition storage unit 83A is divided into a plurality of regions. The collection conditions with different usage purposes are stored in the regions of the collection condition storage unit 83A.

To be specific, the collection condition storage unit 83A is divided into a service region R1, an essential region R2, a development region R3, and an autonomous generation region R4. The service region R1 is, for example, a region for storing collection conditions specified by service that a service provider providing the service for general users or a manager of the data collection apparatus 1A provides to the general users.

The essential region R2 is a region for storing collection conditions with which data collection is essential. For example, the collection conditions related to human life are stored in the essential region R2. To be specific, the collection conditions by emergency vehicles such as a fire engine and a police vehicle are stored in the essential region R2. The data collection condition (data type) for the essential region R2 is, for example, positional information, and the data collection apparatus 1A can grasp the positional information of each vehicle in real time based on the positional information.

When a fire, a traffic accident, or the like occurs near each vehicle, the data collection apparatus 1A transmits a transmission demand for a camera image to the on-vehicle device 50A located in the vicinity of the site. The data collection apparatus 1A provides the camera image to the emergency vehicle, so that the emergency vehicle can check a situation of the site before the emergency vehicle arrives at the site.

The development region R3 is a region for storing collection conditions by the developer of the vehicle. The developer of the vehicle can use actual data collected based on the transmission demand for development of automatic driving vehicles, for example.

The autonomous generation region R4 is a region for storing collection conditions generated by the on-vehicle device 50A itself autonomously. For example, when the on-vehicle device 50A detects abnormality of the vehicle, it can generate the collection condition related to a phenomenon similar to the abnormality and store it in the autonomous generation region R4.

The data collection apparatus 1A can thereby collect the pieces of tag information and the pieces of actual data from the on-vehicle devices 50A, collect pieces of data for specifying the cause of the abnormality, identify the cause based on the pieces of data, and transmit a countermeasure to the on-vehicle device 50A.

The acquisition unit 71A of the controller 7A will be described with reference to FIG. 11 again. The acquisition unit 71A acquires the collection condition and the collection demand from the data collection apparatus 1 A. The acquisition unit 71A updates the collection condition storage unit 83A of the storage unit 8A using the acquired collection condition. The collection condition storage unit 83A of the storage unit 8A can thereby be updated to the latest state (in synchronization with the collection condition stored in the data collection apparatus 1).

That is to say, the collection condition generated by another on-vehicle device 50A is transmitted to the on-vehicle devices 50A through the data collection apparatus 1A.

The detector 72A detects an event satisfying the collection condition stored in the collection condition storage unit 83A. When the detector 72A detects the event satisfying the collection condition stored in the collection condition storage unit 83A, it generates the tag information based on the actual data for the event satisfying the collection condition and notifies the selector 74A and the transmitter 75A of it.

The detector 72A can also detect abnormality of the vehicle, for example. The detector 72A monitors signals input from various sensors and can detect the abnormality of the own vehicle based on the signals. When the detector 72A detects the above-mentioned abnormality, it notifies the generator 73A of information indicating contents of the abnormality.

The generator 73A generates the collection condition of data related to the abnormality detected by the detector 72A. The generator 73A generates the collection condition for collecting data similar to the abnormality detected by the detector 72A.

When the detector 72A detects abnormality for a signal from the vehicle speed sensor 91, for example, the generator 73A can set a signal waveform similar to a signal waveform of the signal as the collection condition. Vehicles in which abnormality similar to that of the own vehicle is detected can be extracted.

The selector 74A stores the actual data satisfying the collection condition in the actual data storage unit 82A while correlating it to the tag information notified by the detector 72A. That is to say, the selector 74A can select the actual data satisfying the collection condition and store it in the actual data storage unit 82A.

When the data collection apparatus 1 transmits the transmission demand, the selector 74A can select, from the actual data storage unit 82A, the actual data specified by the transmission demand (actual data specified by the user, for example, based on the tag information in the data collection apparatus 1A) based on the transmission demand and notify the transmitter 75A of it.

The transmitter 75A transmits, to the data collection apparatus 1A, the collection condition generated by the generator 73A and a collection request of data satisfying the collection condition. The transmitter 75A transmits, to the data collection apparatus 1A, abnormal data and an analysis request of the abnormal data.

The data collection apparatus 1A can thereby collect data similar to the abnormal data. The data collection apparatus 1A analyzes the abnormal data, thereby taking a countermeasure against the abnormal data early.

The transmitter 75A transmits the tag information generated by the above-mentioned detector 72A to the data collection apparatus 1A and transmits the actual data selected by the selector 74A to the data collection apparatus 1A.

The data collection apparatus 1A can thereby provide, to each user, the tag information and the actual data that the user desires.

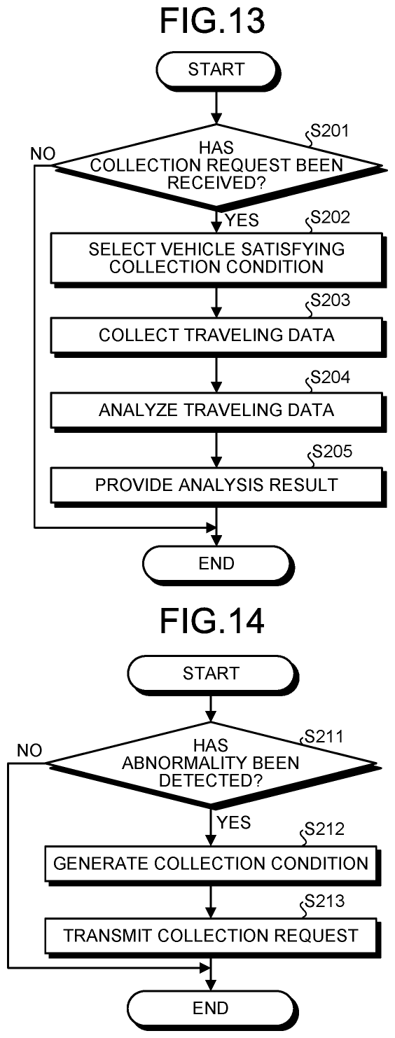

Next, processing procedures that the data collection apparatus 1A in the embodiment executes will be described with reference to FIG. 13. FIG. 13 is a flowchart illustrating the processing procedures that the data collection apparatus 1A in the embodiment executes. With reference to FIG. 13, a series of processing when the data collection apparatus 1A receives the collection request from the on-vehicle device 50A being the request vehicle will be described. This processing is repeatedly executed while the data collection apparatus 1 operates.

First, as illustrated in FIG. 13, the data collection apparatus 1A determines whether it has received a collection request from the on-vehicle device 50A being the request vehicle (step S201). When the data collection apparatus 1A has received the collection request (Yes at step S201), it selects a vehicle satisfying a collection condition (step S202).

Subsequently, the data collection apparatus 1 collects traveling data satisfying the collection condition from the on-vehicle device 50A of the vehicle selected in the processing at step S202 (step S203). Then, the data collection apparatus 1A analyzes the collected traveling data (step S204), provides an analysis result to the on-vehicle device 50A being the request vehicle (step S205), and finishes the processing.

When the data collection apparatus 1A receives no collection request (No at step S201), the processing ends.

Subsequently, processing procedures that each on-vehicle device 50A executes will be described with reference to FIG. 14. FIG. 14 is a flowchart illustrating the processing procedures that the on-vehicle device 50A executes. This processing is repeatedly executed while the on-vehicle device 50A operates.

As illustrated in FIG. 14, first, the on-vehicle device 50A determines whether it has detected an abnormality of the own vehicle (step S211). When the on-vehicle device 50A has detected an abnormality of the own vehicle (Yes at step S211), it generates a collection condition (step S212). The collection condition can be generated by, for example, a method using table data in which collection conditions in accordance with abnormality types are set.

The on-vehicle device 50A transmits a collection request containing the collection condition (step S213) and finishes the processing. When the on-vehicle device 50A detects no abnormality (No at step S211), the processing ends.

In the above-mentioned embodiment, the data collection apparatus 1 or 1A collects the pieces of data from the on-vehicle devices 50 or 50A, but the invention is not limited thereto. That is to say, the data collection apparatus 1 or 1A can also collect pieces of data from terminal devices such as a smart phone and a tablet terminal.

The data collection apparatus 1 or 1A and the on-vehicle devices 50 or 50A may be appropriately combined for use.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An on-vehicle device; includes:
a detector that detects abnormality of an own vehicle;
a generator that generates a collection condition of data in accordance with the abnormality detected by the detector; and
a transmitter that transmits, to the data collection apparatus, a collection request of data with the collection condition generated by the generator.

2. The on-vehicle device according to claim 1, wherein the transmitter transmits, to the external apparatus, an analysis request related to data when abnormality occurs.

3. A data collection system comprising:
an on-vehicle device; and
a data collection apparatus, wherein
the on-vehicle device includes:
a detector that detects abnormality of an own vehicle;
a generator that generates a collection condition of data in accordance with the abnormality detected by the detector; and
a transmitter that transmits, to the data collection apparatus, a collection request of data with the collection condition generated by the generator,
the data collection apparatus includes:
a receiver that receives the collection request from the on-vehicle device;
a transmitter that transmits a data collection demand to cause a data collection target vehicle based on the collection request received by the receiver to perform data collection in accordance with the collection condition; and
a provision unit that provides provision data based on collected data transmitted from the data collection target vehicle based on the data collection demand, and
the on-vehicle device that has acquired the data collection demand acquires data based on the data collection demand and transmits the data to the data collection apparatus.

4. The data collection system according to claim 3, further comprising a user terminal, the data collection system enabling data acquired by the on-vehicle device to be used in the user terminal, wherein
the data collection apparatus
transmits, to the on-vehicle device, a collection demand based on a user data collection demand from the user terminal,
collects tag information of vehicle condition data acquired by a vehicle from the on-vehicle device mounted on the vehicle,
transmits, to the user terminal, selection tag information for data selection by a user based on the tag information,
transmits, to the on-vehicle device, a transmission instruction based on a user data transmission instruction from the user terminal, and
transmits, to the user terminal, user vehicle condition data for data utilization by the user based on the vehicle condition data corresponding to the transmission instruction, the vehicle condition data having been transmitted from the on-vehicle device,
the on-vehicle device includes:
an actual data storage unit that stores the vehicle condition data related to the vehicle from various vehicle condition detection units provided in the vehicle based on the collection demand from the data collection apparatus;
a generator that generates the tag information of the vehicle condition data stored in a vehicle condition data storage unit based on the collection demand; and
a transmitter that transmits the tag information generated by the generator to the data collection apparatus,
the transmitter extracts the vehicle condition data corresponding to the transmission instruction from the vehicle condition data storage unit based on the transmission instruction from the data collection apparatus and transmits the vehicle condition data to the data collection apparatus, and
the user terminal
inputs the user data collection demand of a user and transmits the user data collection demand to the data collection apparatus,
receives the selection tag information transmitted from the on-vehicle device,
provides the received selection tag information to the user,
inputs the user data transmission instruction of the user,
transmits the input user data collection demand to the data collection apparatus,
receives the user vehicle condition data transmitted from the data collection apparatus, and
provides the received user vehicle condition data to the user.

5. The data collection system according to claim 3, wherein the data collection apparatus sets a collection range of the on-vehicle device from which data is collected based on the collection condition generated by the on-vehicle device and extends the collection range in accordance with the number of pieces of collected data.

6. The data collection system according to claim 4, wherein the data collection apparatus extends the data collection range based on relevance information indicating relevance between a mounted device on the own vehicle and mounted devices on other vehicles.

7. A data collection apparatus comprising:
a receiver that receives a collection request of data related to abnormality of a vehicle, the abnormality having been detected by an on-vehicle device;
a transmitter that transmits a data collection demand to cause a data collection target vehicle to perform data collection in accordance with a collection condition based on the collection request received by the receiver; and
a provision unit that provides, to the on-vehicle device having made the collection request, provision data based on collected data transmitted from the data collection target vehicle based on the data collection demand.

8. The data collection apparatus according to claim 7, wherein
the receiver receives a user data collection demand from a user terminal,
the transmitter transmits the user data collection demand to the on-vehicle device,
the receiver receives tag information of vehicle condition data acquired in the vehicle from the on-vehicle device mounted on the vehicle,
the provision unit provides, to the user terminal, selection tag information for data selection by a user based on the tag information,
the transmitter transmits, to the on-vehicle device, a transmission instruction based on a user data transmission instruction from the user terminal, and
the provision unit provides, to the user terminal, user vehicle condition data based on the vehicle condition data corresponding to the transmission instruction, the vehicle condition data having been transmitted from the on-vehicle device.
